(19) United States
(12) Patent Application Publication
(10) Pub. No.: US 2022/0032448 A1
(43) Pub. Date: Feb. 3, 2022

(54) TEACHING METHOD AND ROBOT SYSTEM

(71) Applicant: SEIKO EPSON CORPORATION, Tokyo (JP)

(72) Inventor: Hiroto HIRABAYASHI, MATSUMOTO-SHI (JP)

(21) Appl. No.: 17/389,385

(22) Filed: Jul. 30, 2021

(30) Foreign Application Priority Data
Jul. 30, 2020 (JP) 2020-129066

(51) Int. Cl. B25J 9/00; B25J 9/16; B25J 13/08; B25J 19/02

(52) U.S. Cl. CPC B25J 9/0081; B25J 19/023; B25J 13/089; B25J 9/1651

(57) ABSTRACT

A teaching method includes a teaching step of driving a robot arm, based on an operation instruction by a teacher to a robot having the robot arm, and storing a position and an attitude of the robot arm. The teaching step includes a first storage mode in which the position and the attitude of the robot arm are stored when a teaching instruction is inputted from the teacher, and a second storage mode in which the position and the attitude of the robot arm are stored when a state where a speed of movement of a control point on the robot arm is a predetermined speed or lower or a state where an angular velocity of the control point on the robot arm is a predetermined angular velocity or lower is satisfied for a predetermined time or longer.

The present application is based on, and claims priority from JP Application Serial Number 2020-129066, filed Jul. 30, 2020, the disclosure of which is hereby incorporated by reference herein in its entirety.

### BACKGROUND

### 1. Technical Field

The present disclosure relates to a teaching method and a robot system.

### 2. Related Art

A teaching device used to teach a robot a content of a task before the robot performs various tasks is known. In the case of a teaching device described in JP-A-2006-142480, when a teacher presses a teaching button while moving a robot arm to a position where the robot arm is to operate, the teaching device stores the position and the attitude of the robot arm at the time. Repeating this operation enables the teaching device to store the position and the attitude of the robot arm corresponding to a plurality of positions. As the robot arm is driven based on information about the position and the attitude that are stored, the robot can perform a task.

However, for example, when the teacher fails to press the teaching button, the position and the attitude of the robot arm corresponding to the timing when the teaching button should be pressed are not stored. In this case, a correct teaching cannot be given and the robot cannot perform a correct task.

### SUMMARY

In order to solve at least a part of the foregoing problem, the disclosure can be implemented in the following forms.

A teaching method according to an application example includes a teaching step of driving a robot arm, based on an operation instruction by a teacher to a robot having the robot arm, and storing a position and an attitude of the robot arm. The teaching step includes a first storage mode in which the position and the attitude of the robot arm are stored when a teaching instruction is inputted from the teacher, and a second storage mode in which the position and the attitude of the robot arm are stored when a state where a speed of movement of a control point on the robot arm is a predetermined speed or lower or a state where an angular velocity of the control point on the robot arm is a predetermined angular velocity or lower is satisfied for a predetermined time or longer.

A robot system according to another application example includes: a robot arm; an input unit to which a teaching instruction to the robot arm by a teacher is inputted; a storage unit storing a position and an attitude of the robot arm; and a control unit controlling activation of the robot arm. The control unit executes a first storage mode in which the position and the attitude of the robot arm are stored in the storage unit when the teaching instruction is inputted to the input unit, and a second storage mode in which the position and the attitude of the robot arm are stored when a state where a speed of movement of a control point on the robot arm is a predetermined speed or lower or a state where an angular velocity of the control point on the robot arm is a predetermined angular velocity or lower is satisfied for a predetermined time or longer.

### BRIEF DESCRIPTION OF THE DRAWINGS

FIG. 1 shows a schematic configuration of a first embodiment of a robot system executing a teaching method according to the disclosure.

FIG. 2 is a block diagram of the robot system shown in FIG. 1.

FIG. 3 is a conceptual view for explaining the teaching method executed by the robot system shown in FIG. 1.

FIG. 4 shows the state where the robot system shown in FIG. 1 is teaching, as viewed along each axis of a robot arm.

FIG. 5 shows the state where the robot system shown in FIG. 1 is teaching, as viewed along each axis of the robot arm.

FIG. 6 shows the state where the robot system shown in FIG. 1 is teaching, as viewed along each axis of the robot arm.

FIG. 7 shows a display screen of a teaching device shown in FIG. 1.

FIG. 8 is a flowchart for explaining an example of the teaching method according to the disclosure.

FIG. 9 shows a display screen according to a second embodiment of the robot system executing the teaching method according to the disclosure.

### DESCRIPTION OF EXEMPLARY EMBODIMENTS

The teaching method and the robot system according to the disclosure will now be described in detail, based on preferred embodiments shown in the accompanying drawings.

### First Embodiment

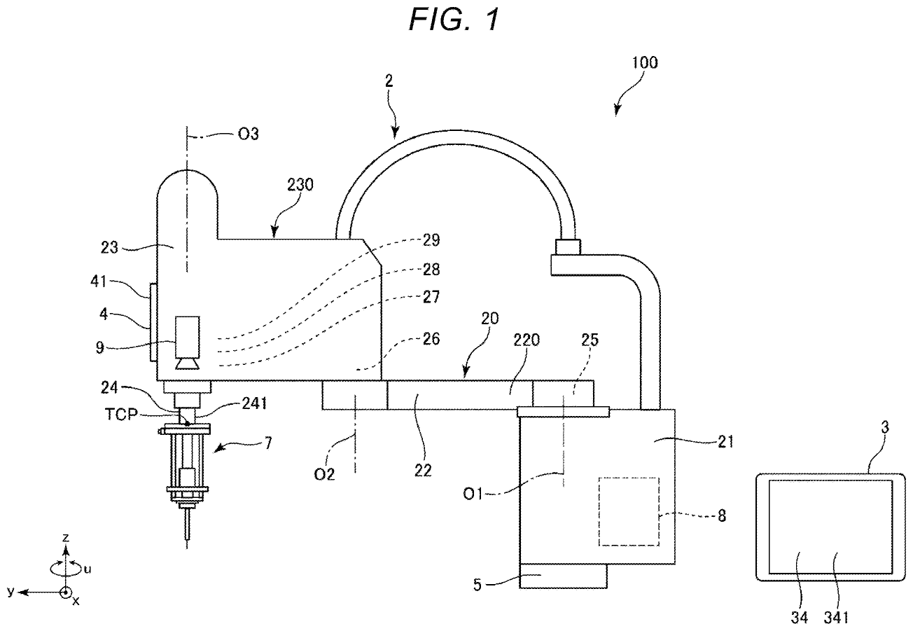

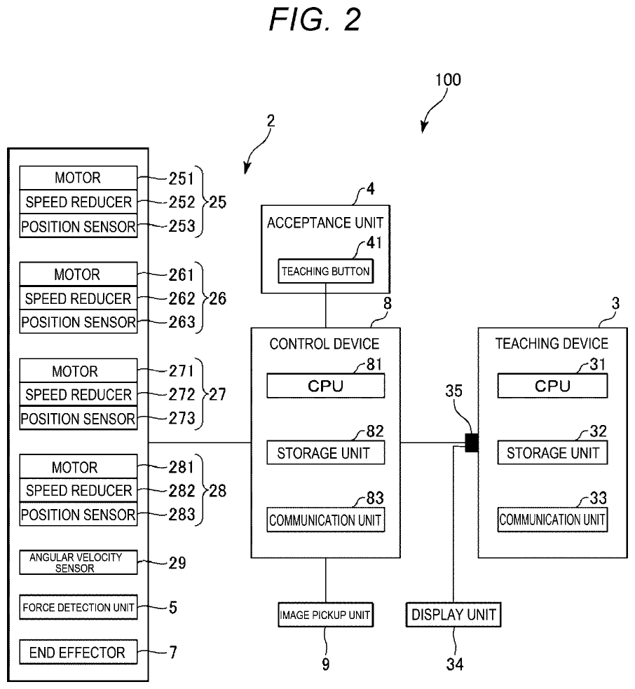

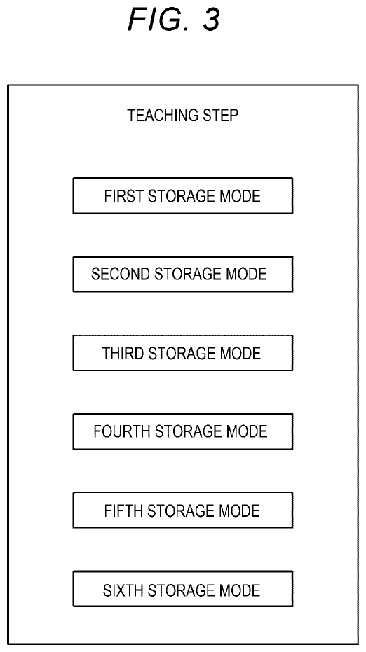

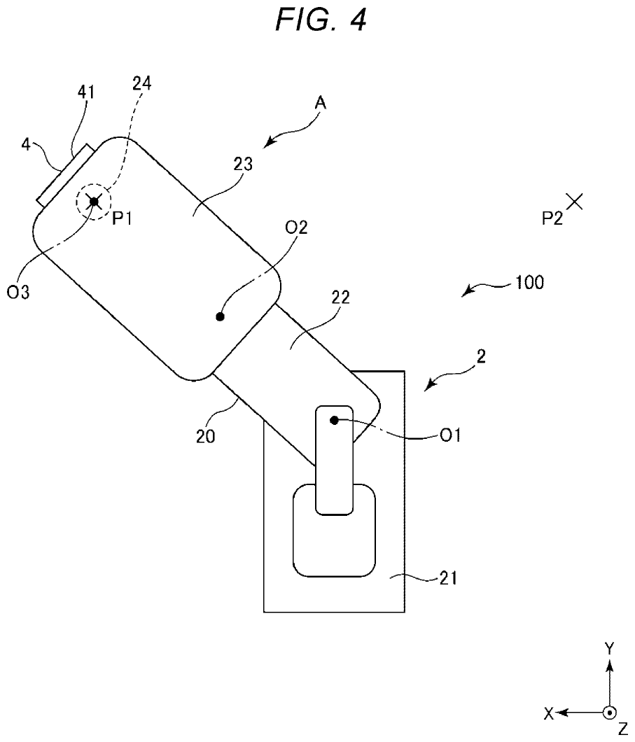

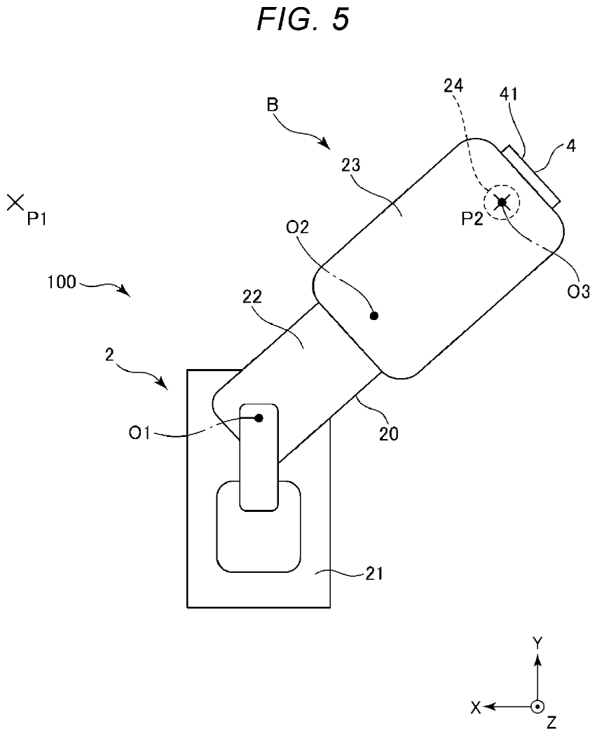

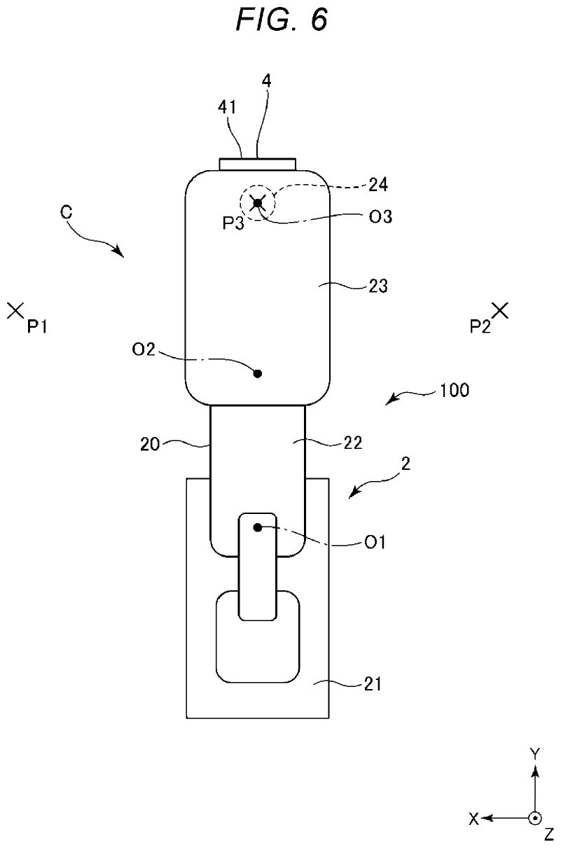

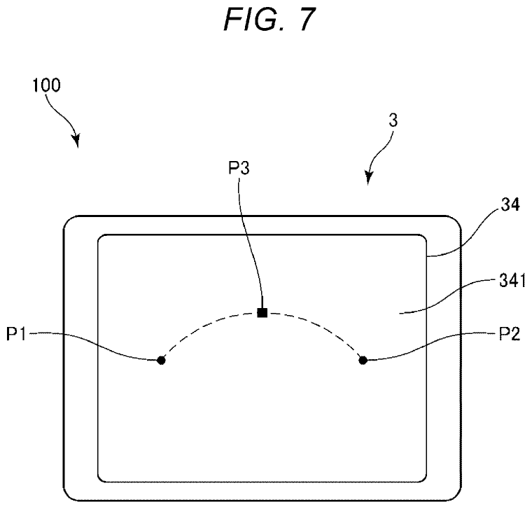

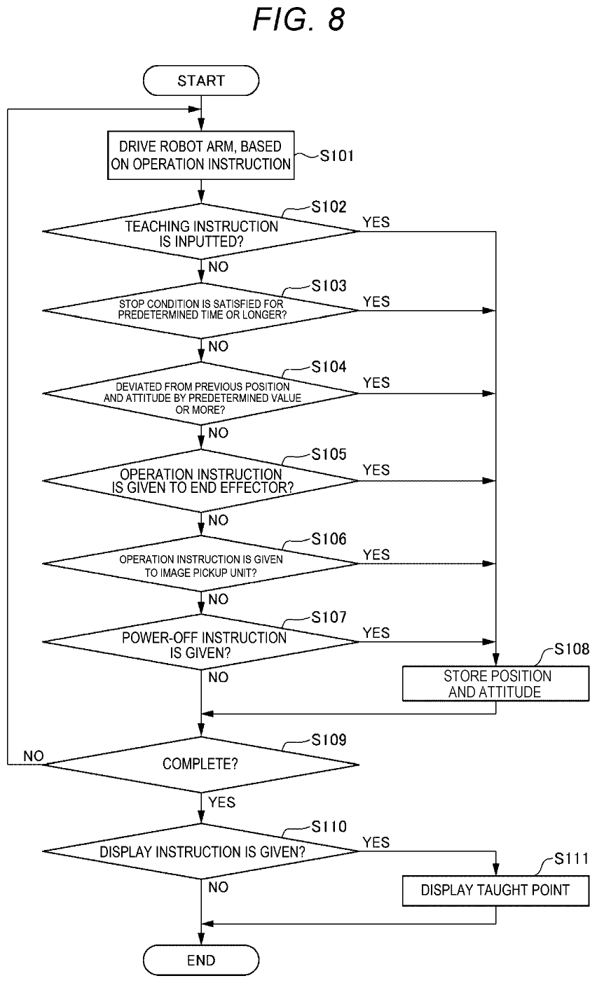

FIG. 1 shows a schematic configuration of a first embodiment of a robot system executing the teaching method according to the disclosure. FIG. 2 is a block diagram of the robot system shown in FIG. 1. FIG. 3 is a conceptual view for explaining the teaching method executed by the robot system shown in FIG. 1. FIG. 4 shows the state where the robot system shown in FIG. 1 is teaching, as viewed along each axis of a robot arm. FIG. 5 shows the state where the robot system shown in FIG. 1 is teaching, as viewed along each axis of the robot arm. FIG. 6 shows the state where the robot system shown in FIG. 1 is teaching, as viewed along each axis of the robot arm. FIG. 7 shows a display screen of a teaching device shown in FIG. 1. FIG. 8 is a flowchart for explaining an example of the teaching method according to the disclosure.

In FIG. 1, for the sake of convenience of the description, an x-axis, a y-axis, and a z-axis are shown as three axes orthogonal to each other. In the description below, a direction parallel to the x-axis is referred to as an “x-axis direction”. A direction parallel to the y-axis is referred to as a “y-axis direction”. A direction parallel to the z-axis direction is referred to as a “z-axis direction”. Also, in the description below, the head side of each of the illustrated arrows is referred to as “+ (positive)” and the rear end side is referred to as “− (negative)”. A direction about the z-axis and a direction about an axis parallel to the z-axis are referred to as a “u-axis direction”.

In the description below, for the sake of convenience of the description, the +z-axis direction in FIG. 1, that is, the upward direction, is referred to as “upward” or “above”, and −z-axis direction, that is, the downward direction, is referred to as “downward” or “below”. As for a robot arm 20, the side of a base 21 in FIG. 1 is referred to as a “proximal end”, and the opposite side, that is, the side of an end effector 7, is referred to as a “distal end”. The z-axis direction in FIG. 1, that is, the up-down direction, is defined as the “vertical direction”. The x-axis direction and the y-axis direction, that is, the left-right direction, is defined as the “horizontal direction”.

In FIGS. 4 to 6, the illustration of an image pickup unit 9 is omitted.

A robot system 100 shown in FIGS. 1 and 2 is, for example, a system used for a task such as holding, conveying, assembling, and inspecting a workpiece of an electronic component and an electronic device or the like. The robot system 100 has a robot 2 and a teaching device 3 teaching the robot 2 an operation program. The robot 2 and the teaching device 3 can communicate with each other via a wire or wirelessly. The communication may be carried out via a network such as the internet.

The teaching refers to designating an operation program to the robot 2, specifically, inputting a position and an attitude or the like of the robot arm 20 to a control device 8. The teaching includes a direct teaching and an indirect teaching.

The direct teaching refers to operating a teaching button 41 of an acceptance unit 4 at a desired timing while applying an external force to the robot arm 20 and moving the robot arm 20 into a predetermined position and attitude, and thus storing an operation of the robot arm 20 in the control device 8 or the teaching device 3.

The indirect teaching refers to preparing an operation program on a display screen 341 of a display unit 34 and storing the prepared operation program in the control device 8 or the teaching device 3, as described in a second embodiment.

First, the robot 2 will be described.

In the illustrated configuration, the robot 2 is a horizontal articulated robot, that is, a SCARA robot. As shown in FIG. 1, the robot 2 has a base 21, a robot arm 20 coupled to the base 21, an acceptance unit 4 accepting a predetermined operation from an operator, a force detection unit 5, an end effector 7, and a control device 8 controlling the activation of these parts.

The base 21 is a part that supports the robot arm 20. The control device 8, described later, is built in the base 21. The origin of a robot coordinate system is set at an arbitrary part of the base 21. The x-axis, the y-axis, and the z-axis shown in FIG. 1 are the axes of the robot coordinate system.

The robot arm 20 has a first arm 22, a second arm 23, and a third arm 24 that is a working head. The robot 2 is not limited to the illustrated configuration. The number of arms may be one, two, or four or more.

The robot 2 has a drive unit 25 rotating the first arm 22 in relation to the base 21, a drive unit 26 rotating the second arm 23 in relation to the first arm 22, a u-drive unit 27 rotating a shaft 241 of the third arm 24 in relation to the second arm 23, a z-drive unit 28 moving the shaft 241 in relation to the second arm 23 in the z-axis direction, and an angular velocity sensor 29.

As shown in FIGS. 1 and 2, the drive unit 25 is built in a casing 220 of the first arm 22 and has a motor 251 generating a drive force, a speed reducer 252 reducing the speed of the drive force of the motor 251, and a position sensor 253 detecting an angle of rotation of a rotation axis of the motor 251 or the speed reducer 252.

The drive unit 26 is built in a casing 230 of the second arm 23 and has a motor 261 generating a drive force, a speed reducer 262 reducing the speed of the drive force of the motor 261, and a position sensor 263 detecting an angle of rotation of a rotation axis of the motor 261 or the speed reducer 262.

The u-drive unit 27 is built in the casing 230 of the second arm 23 and has a motor 271 generating a drive force, a speed reducer 272 reducing the speed of the drive force of the motor 271, and a position sensor 273 detecting an angle of rotation of a rotation axis of the motor 271 or the speed reducer 272.

The z-drive unit 28 is built in the casing 230 of the second arm 23 and has a motor 281 generating a drive force, a speed reducer 282 reducing the speed of the drive force of the motor 281, and a position sensor 283 detecting an angle of rotation of a rotation axis of the motor 281 or the speed reducer 282.

As the motor 251, the motor 261, the motor 271, and the motor 281, for example, a servo motor such as an AC servo motor or a DC servo motor can be used.

As the speed reducer 252, the speed reducer 262, the speed reducer 272, and the speed reducer 282, for example, a planetary gear-type speed reducer, a strain wave gearing device or the like can be used. As the position sensor 253, the position sensor 263, the position sensor 273, and the position sensor 283, for example, an angle sensor can be used.

The drive unit 25, the drive unit 26, the u-drive unit 27, and the z-drive unit 28 are coupled respectively to corresponding motor drivers, not illustrated, and are controlled by the control device 8 via the motor drivers.

The angular velocity sensor 29 is built in the second arm 23, as shown in FIG. 2. Therefore, the angular velocity sensor 29 can detect an angular velocity of the second arm 23. Based on information about the detected angular velocity, the control device 8 controls the robot 2.

The base 21 is fixed, for example, to a floor surface, not illustrated, with a bolt or the like. The first arm 22 is coupled to the upper side of the base 21. The first arm 22 is rotatable about a first axis O1 that is along the vertical direction, in relation to the base 21. When the drive unit 25 rotating the first arm 22 is driven, the first arm 22 rotates within a horizontal plane about the first axis O1 in relation to the base 21. The position sensor 253 can detect the amount of rotation of the first arm 22 in relation to the base 21.

The second arm 23 is coupled to a distal end part of the first arm 22. The second arm 23 is rotatable about a second axis O2 that is along the vertical direction, in relation to the first arm 22. The axial direction of the first axis O1 and the axial direction of the second axis O2 are the same. That is, the second axis O2 is parallel to the first axis O1. When the drive unit 26 rotating the second arm 23 is driven, the second arm 23 rotates within a horizontal plane about the second axis O2 in relation to the first arm 22. The position sensor 263 can detect the amount of driving the second arm 23 in relation to the first arm 22, specifically, the amount of rotation thereof.

The third arm 24 is installed and supported at a distal end part of the second arm 23. The third arm 24 has the shaft 241. The shaft 241 is rotatable about a third axis O3 that is along the vertical direction, in relation to the second arm 23, and is also movable in the up-down direction. The shaft 241 is the most distal-end arm of the robot arm 20.

When the u-drive unit 27 rotating the shaft 241 is driven, the shaft 241 rotates about the z-axis. The position sensor 273 can detect the amount of rotation of the shaft 241 in relation to the second arm 23.

When the z-drive unit 28 moving the shaft 241 in the z-axis direction is driven, the shaft 241 moves in the up-down direction, that is, in the z-axis direction. The position sensor 283 can detect the amount of movement of the shaft 241 in the z-axis direction in relation to the second arm 23.

In the robot 2, the distal end of the shaft 241 is defined as a control point TCP, and a distal-end coordinate system in which the control point TCP is the origin is set. The distal-end coordinate system is already calibrated with the foregoing robot coordinate system. A position in the distal-end coordinate system can be converted into a position in the robot coordinate system. Thus, the position of the control point TCP can be specified in the robot coordinate system. However, the control point TCP is not limited to this position and can be set at any position that is specified using the robot coordinate system.

Any one of various end effectors is removably coupled to the distal end part of the shaft 241. The end effector is not particularly limited and may be, for example, an end effector gripping an object to be conveyed, an end effector processing an object to be processed, an end effector used for inspection, or the like. In this embodiment, the end effector 7 is removably coupled.

In this embodiment, the end effector 7 is not a component of the robot 2. However, a part or the entirety of the end effector 7 may be a component of the robot 2.

As shown in FIG. 1, the force detection unit 5 is configured to detect a force applied to the robot 2, that is, a force applied to the robot arm 20 and the base 21. In this embodiment, the force detection unit 5 is provided below the base 21, that is, to the −z-axis side of the base 21, and supports the base 21 from below.

The force detection unit 5 is formed, for example, of a piezoelectric body such as quartz crystal and can be configured with a plurality of elements that output an electric charge when receiving an external force. The control device 8 can convert the amount of electric charge into the external force applied to the robot arm 20. Such a piezoelectric body enables adjustment of the direction in which an electric charge can be generated when an external force is applied, according to the direction of installation.

The acceptance unit 4 is a part that accepts a predetermined operation by the operator. The acceptance unit 4 has the teaching button 41. The teaching button 41 can be used when giving the direct teaching. The teaching button 41 may be a mechanical button or an electrical touch button. Also, a button with a different function may be installed around the teaching button 41.

An image pickup unit 9 can be configured, for example, with an image pickup element formed of a CCD (charge-coupled device) image sensor having a plurality of pixels, and an optical system including a lens or the like. As shown in FIG. 2, the image pickup unit 9 is electrically coupled to the control device 8 and has its activation controlled by the control device 8. That is, when an image pickup command is inputted via the teaching device 3, its signal is transmitted to the control device 8, and the control device 8 drives the image pickup unit 9 to perform image pickup.

The image pickup unit 9 converts light received by the image pickup element into an electrical signal and outputs the electrical signal to the control device 8. That is, the image pickup unit 9 transmits the result of the image pickup to the control device 8. The result of the image pickup may be a still image or a video.

The image pickup unit 9 may be configured to be controlled directly by the teaching device 3 without using the control device 8.

The image pickup unit 9 is installed at a lateral part of the second arm 23 and faces downward, and picks up an image of a space below the second arm 23. The position of installation of the image pickup unit 9 and the direction in which the image pickup unit 9 faces are not limited to the illustrated configuration.

The control device 8 will now be described.

As shown in FIGS. 1 and 2, in this embodiment, the control device 8 is built in the base 21. As shown in FIG. 2, the control device 8 has the function of controlling the driving of the robot 2 and is electrically coupled to each of the foregoing parts of the robot 2. The control device 8 has a CPU (central processing unit) 81, a storage unit 82, and a communication unit 83. These units are coupled in such a way as to be able to communicate with each other, for example, via a bus.

The CPU 81 reads out and executes various programs or the like stored in the storage unit 82. A command signal generated by the CPU 81 is transmitted to the robot 2 via the communication unit 83. Thus, the robot arm 20 can execute a predetermined task.

The storage unit 82 saves various programs or the like executable by the CPU 81. The storage unit 82 may be, for example, a volatile memory such as a RAM (random-access memory), a non-volatile memory such as a ROM (read-only memory), a removable external storage device, or the like.

The communication unit 83 transmits and receives a signal to and from each part of the robot 2 and the teaching device 3, using an external interface such as a wired LAN (local area network) or a wireless LAN.

The teaching device 3 will now be described.

As shown in FIG. 2, the teaching device 3 has a CPU 31, a storage unit 32, a communication unit 33, a display unit 34, and an input unit 35. The teaching device 3 is not particularly limited and may be, for example, a tablet, a personal computer, a smartphone, a teaching pendant or the like.

The CPU 31 reads out and executes various programs or the like stored in the storage unit 32 and thus controls the activation of the robot arm 20. The various programs include, for example, a teaching program, described later, and the like. The teaching program may be generated by the teaching device 3, or may be stored from an external recording medium such as a CD-ROM, or may be stored via a network or the like.

A signal generated by the CPU 31 is transmitted to the control device 8 of the robot 2 via the communication unit 33. Thus, the robot arm 20 can execute a predetermined task under a predetermined condition or can give a teaching. The CPU 31 also controls the driving of the display unit 34 shown in FIGS. 1 and 2. That is, the CPU 31 functions as a display control unit that controls the activation of the display unit 34.

The storage unit 32 saves various programs or the like executable by the CPU 31. The storage unit 32 may be, for example, a volatile memory such as a RAM (random-access memory), a non-volatile memory such as a ROM (read-only memory), a removable external storage device, or the like.

The communication unit 33 transmits and receives a signal to and from the control device 8, using an external interface such as a wired LAN (local area network) or a wireless LAN.

The display unit 34 is formed of any one of various displays having the display screen 341. In this embodiment, an example where the display unit 34 is a touch panel, that is, where the display unit 34 is configured to have a display function and an input operation function, is described. When the operator touches the display screen 341, the CPU 31 performs control to switch to a predetermined display content.

However, such a configuration is not limiting. A configuration having a separate input operation unit may be employed. In this case, the input operation unit may be, for example, a mouse, a keyboard or the like. Also, a configuration using both a touch panel and a mouse or a keyboard or the like may be employed. That is, the input operation described below may be configured as moving and selecting a cursor displayed on the display screen 341, using the mouse or the keyboard or the like.

The input unit 35 is an input terminal to which the control device 8 and the display unit 34 are coupled. To the input unit 35, various kinds of information from the control device 8 and information about various settings or the like inputted from the display unit 34 are inputted. When the teacher presses the teaching button 41, its information is inputted to the input unit 35 via the control device 8. That is, the input unit 35 is a part to which a teaching instruction to the robot arm 20 by the teacher is inputted. However, the illustrated configuration is not limiting. A configuration in which the information from the teaching button 41 is directly inputted to the input unit 35 may be employed.

The teaching method according to the disclosure will now be described. In the description below, a case where the robot arm 20 is to perform a task starting at a position A shown in FIG. 4 as a task start position and ending at a position B shown in FIG. 5 as a task end position is described. In this case, the correct teaching is to press the teaching button 41 at the position A shown in FIG. 4 and press the teaching button 41 at the position B shown in FIG. 5. Also, in the description below, the teaching given by the teacher is assumed to be the direct teaching.

First, the teacher grips a part of the robot arm 20, for example, the second arm 23, applies a force to the robot arm 20, and thus moves the robot arm 20. The teacher locates the control point TCP at a position P1 shown in FIG. 4 and then presses the teaching button 41. Thus, a teaching instruction is inputted to the control device 8 and the teaching device 3, and information about the position and the attitude of the robot arm 20 at the time, that is, the position and the attitude of the robot arm 20 corresponding to the case where the control point TCP is located at the position P1, are stored in the storage unit 32.

In this specification, “storing the position and the attitude of the robot arm 20” refers to storing the three-dimensional coordinates of the control point TCP in the robot coordinate system and the angle of the joint of the robot arm 20 at the time. The angle of the joint of the robot arm 20 is detection values from the position sensor 253, the position sensor 263, the position sensor 273, and the position sensor 283.

Next, the teacher grips the second arm 23, applies a force to the robot arm 20 to move the robot arm 20, and thus move the control point TCP to a position P2 shown in FIG. 5. Then, the teacher stops applying a force to the robot arm 20 and presses the teaching button 41. Thus, the position and the attitude of the robot arm 20 corresponding to the case where the control point TCP is located at the position P2 are stored in the storage unit 32.

In this way, a task start position and a task end position are stored and an operation program to make the robot arm 20 move from the task start position to the task end position is prepared. By executing this operation program, the robot arm 20 can perform a desired task. At the task start position, the task end position, or any point between these positions, an operation instruction to the end effector 7 or the image pickup unit 9 can be inputted. When an operation instruction to the end effector 7 or the image pickup unit 9 is inputted, the operation program is prepared, incorporating a program of the operation instruction.

Although the teacher is supposed to press the teaching button 41, for example, at the position A or the position B, the teacher may fail to press the teaching button 41. Also, when the teacher temporarily interrupts a teaching and then resumes the teaching, the teacher may lose track of the position where the interruption has taken place. In such cases, a correct teaching cannot be given and therefore a desired task cannot be performed.

To prevent such trouble, the teaching device 3 has a first storage mode, a second storage mode, a third storage mode, a fourth storage mode, a fifth storage mode, and the sixth storage mode, as shown in FIG. 3. When a condition set for each mode is satisfied, the position and the attitude of the robot arm 20 at the time are stored in the storage unit 32. Thus, the failure to press the teaching button 41 is prevented and a correct teaching can be given.

The first storage mode is a normal storage mode in which the position and the attitude of the robot arm 20 are stored when a teaching instruction is inputted from the teacher. That is, when the teacher presses the teaching button 41, the position and the attitude of the robot arm 20 at the time are stored in the storage unit 32. Thus, when the teacher presses the teaching button 41 at a desired position, the position and the attitude of the robot arm 20 can be stored.

In this way, the trigger of execution of the first storage mode is information that the teaching button 41 is pressed.

The second storage mode is a mode in which the position and the attitude of the robot arm 20 are stored when the state where the speed of movement of the control point TCP is a predetermined speed or lower, or the state where the angular velocity of the control point TCP is a predetermined angular velocity or lower, is satisfied for a predetermined time or longer. In other words, the second storage mode is a mode in which the position and the attitude of the robot arm 20 are stored when a stop condition that the speed of movement of the control point TCP can be regarded as stopped or that the attitude of the robot arm 20 can be regarded as not changed is satisfied. In the second storage mode, the position and the attitude of the robot arm 20 are stored when at least one of “the state where the speed of movement of the control point TCP is a predetermined speed or lower” and “the state where the angular velocity of the control point TCP is a predetermined angular velocity or lower” is satisfied for a predetermined time or longer.

The speed of movement of the control point TCP can be calculated, for example, by predicting the speed of each joint or by picking up an image of the control point TCP by the image pickup unit 9 and estimating the speed of movement.

The predetermined speed can be, for example, approximately 1 mm/s or higher and 20 mm/s or lower. The predetermined time can be, for example, approximately 1 second or longer and 10 seconds or shorter.

The angular velocity of the control point TCP can be calculated, for example, by predicting the speed of each joint or by detecting the angular velocity by the angular velocity sensor 29.

The predetermined angular velocity can be, for example, approximately 0.1 deg/s or higher and 2 deg/s or lower. The predetermined time can be, for example, approximately 1 second or longer and 10 seconds or shorter.

In such a second storage mode, the position and the attitude of the robot arm 20 can be automatically stored when the robot arm 20 is stopped. Thus, for example, when the teacher temporarily interrupts a teaching, the position and the attitude of the robot arm 20 at the time can be stored. Therefore, the teacher can resume the teaching from that point.

That the robot arm 20 is stopped or is moving at a low speed for a predetermined time or longer means that the robot arm 20 may be at an important position for performing a task. Therefore, forcibly storing that position enables the storage of the position and the attitude even when the teacher fails to press the teaching button 41. This can prevent the failure to press the teaching button 41.

The third storage mode is a mode in which the position and the attitude of the robot arm 20 are stored when the deviation between the position and the attitude of the robot arm 20 and a position and an attitude of the robot arm 20 that are already stored is a predetermined value or greater. That “the deviation of the position and the attitude of the robot arm 20 is a predetermined value or greater” means that the position in the robot coordinate system is deviated by a predetermined value or more. That is, it means that the robot arm 20 has moved relatively largely and has changed in attitude.

In this case, it often tends to be a timing when the position and the attitude of the robot arm 20 should be stored. Therefore, having the third storage mode can prevent the failure to press the teaching button 41.

The fourth storage mode is a mode in which the position and the attitude of the robot arm 20 are stored when an operation command to the end effector 7 installed at the robot arm 20 is inputted. The operation command to the end effector 7 is a command to move the end effector 7 up and down or to activate the end effector 7. The operation command is inputted, for example, by the teacher via the teaching device 3, and its signal is inputted to the end effector 7 via the control device 8.

That an operation command is inputted to the end effector 7 means that the robot arm 20 is at an important position for performing a task. Therefore, forcibly storing that position enables the storage of the position and the attitude even when the teacher fails to press the teaching button 41. This can prevent the failure to press the teaching button 41.

The fifth storage mode is a mode in which the position and the attitude of the robot arm 20 are stored when an operation command to the image pickup unit 9 picking up an image of a target object to be worked by the robot arm 20 is executed. The operation command to the image pickup unit 9 is a command causing the image pickup unit 9 to perform image pickup. This operation command is inputted, for example, by the teacher via the teaching device 3, and its signal is inputted to the image pickup unit 9 via the control device 8.

That an operation command is inputted to the image pickup unit 9 means that the robot arm 20 is at an important position for performing a task. Therefore, forcibly storing that position enables the storage of the position and the attitude even when the teacher fails to press the teaching button 41. This can prevent the failure to press the teaching button 41.

In the sixth storage mode, the position and the attitude of the robot arm 20 are stored when a command to turn off the power of the robot 2 is inputted. When the teacher presses a power button, not illustrated, information of the command to turn off the power of the robot 2 is inputted, for example, to the input unit 35 of the teaching device 3.

The robot arm 20 may be set to return to its initial position when the power is turned off in the middle of a teaching, for example, at a position as shown in FIG. 6. In this case, the teacher loses track of which position to resume the teaching and therefore needs to redo the teaching from the beginning. Therefore, storing the position and the attitude of the robot arm 20 when the command to turn off the power of the robot 2 is inputted, enables accurate resumption of the task.

In this way, in the robot system 100, the second to sixth storage modes are executed while the first storage mode, which is the normal storage mode, is executed. This can prevent a teaching error due to the failure to press the teaching button 41 and enables a teaching to be given at a proper timing of teaching. Thus, a correct teaching can be given and therefore the robot 2 can perform a correct task.

While the configuration in which the first to sixth storage modes are executed is described above, the disclosure is not limited to this configuration. A configuration in which at least the first and second storage modes are executed can sufficiently achieve the effects of the disclosure.

As described above, the robot system 100 has the robot arm 20, the input unit 35 to which a teaching instruction to the robot arm 20 by a teacher is inputted, the storage unit 32 storing a position and an attitude of the robot arm 20, and the CPU 31, which is a control unit controlling the activation of the robot arm 20. The CPU 31 executes the first storage mode, in which the position and the attitude of the robot arm 20 are stored in the storage unit 32 when the teaching instruction is inputted to the input unit 35, and the second storage mode, in which the position and the attitude of the robot arm 20 are stored when the state where the speed of movement of the control point TCP on the robot arm 20 is a predetermined speed or lower or the state where the angular velocity of the control point TCP on the robot arm 20 is a predetermined angular velocity or lower is satisfied for a predetermined time or longer. This can prevent, for example, a teaching error due to the failure to press the teaching button 41 and enables a teaching to be given at a proper timing of teaching. Thus, a correct teaching can be given and therefore the robot 2 can perform a correct task.

In the robot system 100, taught stored data, that is, a taught path of the robot arm 20, can be displayed on the display unit 34. For example, the display unit 34 displays a position P1, a position P2, and a position P3 between the positions P1 and P2, as shown in FIG. 7. The positions P1 and P2 are displayed as circular marks. The position P3 is displays as a quadrilateral mark. The position P3 is the teaching information of the robot arm 20 stored in one of the second to sixth storage modes.

In the illustrated configuration, the position of the control point TCP is displayed two-dimensionally. However, the disclosure is not limited to this configuration. A configuration in which the position and the attitude of the robot arm 20 are shown three-dimensionally may be employed.

Such a display step may be executed when an instruction to display a teaching content is given, or may be executed automatically on completion of the teaching step. The display instruction can be inputted, for example, by the teacher via the teaching device 3.

As illustrated, the configuration in which the marks are distinguished from each other by shape is not limiting. A configuration in which the marks are distinguished from each other by color, size or the like may be employed.

As the teaching information in the first storage mode and the teaching information in the second storage mode are displayed in such a way as to be distinguished from each other in this way, the teacher can easily grasp at which position the teacher has failed to press the teaching button or which position to resume the task.

A control operation performed by the CPU 31 will now be described based on a flowchart shown in FIG. 8. The steps described below may be split to the CPU 31 and the CPU 81.

First, in step S101, the robot arm 20 is driven to start a teaching, based on an operation instruction. In this embodiment, the operation instruction is a force applied to the robot arm 20 by the teacher. However, the operation instruction is not limited to this and may be an operation of moving the robot arm 20 via the teaching device 3.

Next, in step S102, whether a teaching instruction is inputted or not is determined. In this embodiment, whether the teaching button 41 is pressed or not is determined. When it is determined in step S102 that a teaching instruction is inputted, the processing shifts to step S108 and the position and the attitude of the robot arm 20 at the time are stored. Meanwhile, when it is determined in step S102 that a teaching instruction is not inputted, the processing shifts to step S103.

Next, in step S103, whether the speed of movement or the angular velocity of the control point TCP satisfies a stop condition for a predetermined time or longer, or not, is determined. When it is determined in step S103 that the stop condition is satisfied for the predetermined time or longer, the processing shifts to step S108 and the position and the attitude of the robot arm 20 at the time are stored. Meanwhile, when it is determined in step S103 that the speed of movement or the angular velocity of the control point TCP does not satisfy the stop condition for the predetermined time or longer, the processing shifts to step S104.

Next, in step S104, whether the current position and attitude of the robot arm 20 are deviated from the previously stored position and attitude of the robot arm 20 by a predetermined value or more, or not, is determined. When it is determined in step S104 that the position and the attitude are deviated by the predetermined value or more, the processing shifts to step S108 and the position and the attitude of the robot arm 20 at the time are stored. Meanwhile, when it is determined in step S104 that the current position and attitude of the robot arm 20 are not deviated from the previously stored position and attitude of the robot arm 20 by the predetermined value or more, the processing shifts to step S105.

Next, in step S105, whether an operation instruction is given to the end effector 7 or not is determined. When it is determined that an operation instruction is given to the end effector 7, the processing shifts to step S108 and the position and the attitude of the robot arm 20 at the time are stored. Meanwhile, when it is determined in step S105 that an operation instruction is not given to the end effector 7, the processing shifts to step S106.

Next, in step S106, whether an operation instruction is given to the image pickup unit 9 or not is determined. When it is determined that an operation instruction is given to the image pickup unit 9, the processing shifts to step S108 and the position and the attitude of the robot arm 20 at the time are stored. Meanwhile, when it is determined in step S106 that an operation instruction is not given to the image pickup unit 9, the processing shifts to step S107.

Next, in step S107, whether an instruction to turn off the power is given or not is determined. When it is determined that an instruction to turn off the power is given, the processing shifts to step S108 and the position and the attitude of the robot arm 20 at the time are stored. Meanwhile, when it is determined in step S107 that an instruction to turn off the power is not given, the processing shifts to step S109.

Next, in step S109, whether the teaching is complete or not is determined. In this step, the determination is made based on whether the teacher has pressed the teaching button 41 or not. When it is determined in step S109 that the teaching is complete, the teaching program is ended and the processing shifts to step S110. Meanwhile, when it is determined in step S109 that the teaching is not complete, the processing returns to step S101 and the subsequent steps are repeated in order.

Next, in step S110, whether a display instruction is given or not is determined. That is, whether a display button, not illustrated, on the display unit 34 of the teaching device 3 is pressed or not is determined. When it is determined in step S110 that a display instruction is given, the result of the teaching is displayed in step S111, for example, as shown in FIG. 7. Meanwhile, when it is determined in step S110 that a display instruction is not given, all the programs are ended.

Of such steps S101 to S111, steps S101 to S109 form the teaching step and steps S110 and S111 form the display step.

As described above, the teaching method according to the disclosure includes the teaching step of driving the robot arm 20, based on an operation instruction by the teacher to the robot 2 having the robot arm 20, and storing the position and the attitude of the robot arm 20. The teaching step includes the first storage mode, in which the position and the attitude of the robot arm 20 are stored when a teaching instruction is inputted from the teacher, and the second storage mode, in which the position and the attitude of the robot arm 20 are stored when the state where the speed of movement of the control point TCP on the robot arm 20 is a predetermined speed or lower or the state where the angular velocity of the control point TCP on the robot arm 20 is a predetermined angular velocity or lower is satisfied for a predetermined time or longer. This can prevent a teaching error due to the failure to press the teaching button 41 and enables a teaching to be given at a proper timing of teaching. Thus, a correct teaching can be given and therefore the robot 2 can perform a correct task.

The teaching step also includes the third storage mode, in which the position and the attitude of the robot arm 20 are stored when the deviation between the position and the attitude of the robot arm 20 and a position and an attitude of the robot arm 20 that are already stored is a predetermined value or greater. Thus, a teaching error due to the failure to press the teaching button 41 can be prevented.

The teaching step also includes the fourth storage mode, in which the position and the attitude of the robot arm 20 are stored when an operation command to the end effector 7 installed at the robot arm 20 is inputted. Thus, a teaching error due to the failure to press the teaching button 41 can be prevented.

The teaching step also includes the fifth storage mode, in which the position and the attitude of the robot arm 20 are stored when an operation command to the image pickup unit 9 picking up an image of a target object to be worked by the robot arm 20 is executed. Thus, a teaching error due to the failure to press the teaching button 41 can be prevented.

The teaching step also includes the sixth storage mode, in which the position and the attitude of the robot arm 20 are stored when a command to turn off the power of the robot 2 is inputted. Thus, when resuming the teaching, the position to resume can be easily grasped.

The teaching method according to the disclosure also includes the display step of displaying the position and the attitude of the robot arm 20, based on the stored data of the position and the attitude of the robot arm 20 stored in the teaching step.

In the display step, the position and the attitude of the robot arm 20 stored in the first storage mode and the position and the attitude of the robot arm 20 stored in a storage mode other than the first storage mode are displayed in such a way as to be distinguished from each other. Thus, the teacher can easily grasp at which position the teacher has failed to press the teaching button or which position to resume the task.

### Second Embodiment

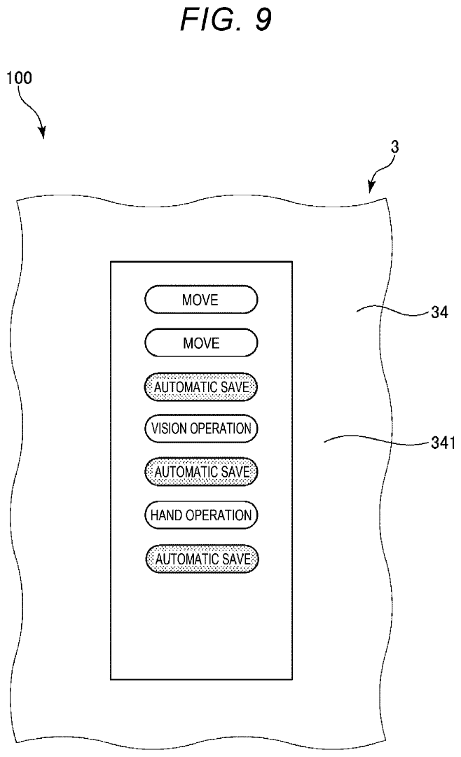

FIG. 9 shows a display screen according to a second embodiment of the robot system executing the teaching method according to the disclosure.

The second embodiment of the teaching method and the robot system according to the disclosure will now be described with reference to FIG. 9 in terms of its difference from the first embodiment.

In this embodiment, the indirect teaching is described. As shown in FIG. 9, in this embodiment, a teaching is given on the display screen 341 of the display unit 34 of the teaching device 3. That is, a teaching is given by arranging one teaching command after another on the display screen 341.

In the illustrated configuration, a “move” command, a “move” command, an “automatic save” command, a “vision operation” command, an “automatic save” command, a “hand operation” command, and an “automatic save” command are arranged from the top.

These commands are selected by the teacher from a command set, not illustrated. When “move” command is selected, a target position can be set via a position setting section, not illustrated, in the display screen 341.

In the illustrated example, when the “move” command is set twice in a row, the stop condition of the robot arm 20 is satisfied. Therefore, automatic save is performed. That is, the position and the attitude of the robot arm 20 at the time are stored.

Subsequently, the “vision operation” command is selected. That is, an operation command to the image pickup unit 9 is inputted. Therefore, the position and the attitude of the robot arm 20 at the time are stored.

Subsequently, the “hand operation” command is selected. That is, an operation command to the end effector 7 is inputted. Therefore, the position and the attitude of the robot arm 20 at the time are stored.

In this way, the first to sixth storage modes can be executed even in the indirect teaching. This prevents, for example, a teaching error due to the failure to press the teaching button 41 and enables a teaching to be given at a proper timing of teaching. Thus, a correct teaching can be given and therefore the robot 2 can perform a correct task.

The teaching method and the robot system according to the disclosure have been described, based on the illustrated embodiments. However, the disclosure is not limited to these embodiments. The configuration of each part can be replaced with any configuration having similar functions. Any other component or step may be added to the teaching method and the robot system. Although a SCARA robot is used as the robot, this is not limiting. A vertical articulated robot or an orthogonal robot may be used.

What is claimed is:

1. A teaching method comprising a teaching step of driving a robot arm, based on an operation instruction by a teacher to a robot having the robot arm, and storing a position and an attitude of the robot arm,
the teaching step including:
a first storage mode in which the position and the attitude of the robot arm are stored when a teaching instruction is inputted from the teacher; and
a second storage mode in which the position and the attitude of the robot arm are stored when a state where a speed of movement of a control point on the robot arm is a predetermined speed or lower or a state where an angular velocity of the control point on the robot arm is a predetermined angular velocity or lower is satisfied for a predetermined time or longer.

2. The teaching method according to claim 1, wherein
the teaching step includes a third storage mode in which the position and the attitude of the robot arm are stored when a deviation between the position and the attitude of the robot arm and a position and an attitude of the robot arm that are already stored is a predetermined value or greater.

3. The teaching method according to claim 1, wherein
the teaching step includes a fourth storage mode in which the position and the attitude of the robot arm are stored when an operation command to an end effector installed at the robot arm is inputted.

4. The teaching method according to claim 1, wherein
the teaching step includes a fifth storage mode in which the position and the attitude of the robot arm are stored when an operation command to an image pickup unit picking up an image of a target object to be worked by the robot arm is executed.

5. The teaching method according to claim 1, wherein
the teaching step includes a sixth storage mode in which the position and the attitude of the robot arm are stored when a command to turn off a power of the robot is inputted.

6. The teaching method according to claim 1, further comprising
a display step of displaying the position and the attitude of the robot arm, based on stored data of the position and the attitude of the robot arm stored in the teaching step.

7. The teaching method according to claim 6, wherein
in the display step, the position and the attitude of the robot arm stored in the first storage mode and the position and the attitude of the robot arm stored in a storage mode other than the first storage mode are displayed in such a way as to be distinguished from each other.

8. A robot system comprising:
a robot arm;
an input unit to which a teaching instruction to the robot arm by a teacher is inputted;
a storage unit storing a position and an attitude of the robot arm; and
a control unit controlling activation of the robot arm;
the control unit executing
a first storage mode in which the position and the attitude of the robot arm are stored in the storage unit when the teaching instruction is inputted to the input unit, and
a second storage mode in which the position and the attitude of the robot arm are stored when a state where a speed of movement of a control point on the robot arm is a predetermined speed or lower or a state where an angular velocity of the control point on the robot arm is a predetermined angular velocity or lower is satisfied for a predetermined time or longer.
